(19) United States
(12) Patent Application Publication
(10) Pub. No.: US 2024/0116000 A1
(43) Pub. Date: Apr. 11, 2024

(54) HOLLOW FIBER IMMERSED MEMBRANE MODULE AND CASSETTE WITH HIGH PACKING DENSITY AND VERTICAL PERMEATE PORT CONNECTIONS

(71) Applicant: BL Technologies, Inc., Minnetonka, MN (US)

(72) Inventors: Ivan ANDJELIC, Oakville (CA); Nicholas William H. ADAMS, Oakville (CA); Reid BAYLY, Oakville (CA); Gavin James BOYLE, Oakville (CA)

(21) Appl. No.: 18/552,116

(22) PCT Filed: Mar. 21, 2022
(86) PCT No.: PCT/US2022/021131

§ 371 Date: Sep. 22, 2023

Related U.S. Application Data
(60) Provisional application No. 63/167,435, filed on Mar. 29, 2021.

(51) Int. Cl. B01D 61/18; B01D 63/04

(52) U.S. Cl. CPC B01D 61/18; B01D 63/04; B01D 2313/21; B01D 2315/06

(57) ABSTRACT

An immersed membrane cassette has a high tank intensity achieved by one or more of: reduced module to module gap; using structural hollow tubing in at least parts of a frame in place of separate permeate and/or air pipes; and, using vertical permeate port connections. The cassette has a tank intensity over 650 m²/m². The cassette may be combined with a fine screen. This specification also describes an immersed membrane module having a permeate port and/or connector on the top of a header. The permeate connection between the module and a permeate collection tube may be vertical, i.e. perpendicular to the length of the header. A piston seal may be used between the permeate port of the header and the permeate collection tube. The permeate collection tube may be a horizontal structural member on the periphery of a frame that holds the module.

### CROSS-REFERENCE TO RELATED APPLICATIONS

This application claims the benefit of U.S. Application Ser. No. 63/167,435, filed Mar. 29, 2021, which is incorporated herein by reference.

### FIELD

This specification relates to immersed hollow fiber membrane modules, cassettes and systems.

### BACKGROUND

International Publication Number WO 02/094421, Immersed Membrane Apparatus, describes an immersed membrane cassette. The cassette has a plurality of membrane modules (alternatively called elements) and a frame for holding the modules while they are immersed in water being filtered by the membranes. Each module has a plurality of hollow fiber membranes attached to and suspended between an upper header and a lower header. The lumens of the membranes are in fluid communication permeate channels in the headers. Connections between the permeate channels and one or more permeate collection tubes attached to the frame are made or broken by sliding an element into or out of the frame.

### INTRODUCTION

This specification describes an immersed membrane cassette with high tank intensity (alternatively called footprint intensity) achieved by one or more of: gaps between modules used in mixed liquor of 20 mm or less or 15 mm or less; using structural hollow tubing in at least parts of a frame, for example in a horizontal frame member, to carry permeate and/or air in place of separate permeate and/or air pipes; and, permeate ports on the top of upper headers. The cassette may have a tank intensity over 650 m²/m² when used in mixed liquor, for example in the range of 750-900 m²/m². The cassette may have a tank intensity over 900 m²/m² when used to filter drinking water or for tertiary filtration, for example in the range of 900-1000 m²/m².

This specification also describes an immersed membrane system having a cassette with a tank intensity over 650 m²/m² when used in mixed liquor, for example in the range of 750-900 m²/m², in combination with a fine screen and/or primary clarifier. The fine screen and/or clarifier may be located upstream of the cassette. A fine screen may have 1-3 mm square or round openings or other openings with a maximum dimension measured through the geometric center in the range of 1-4.5 mm.

This specification also describes a process wherein mixed liquor is screened to have less than 2 mg/L trash and filtered with an immersed membrane module having a tank intensity over 650 m²/m², for example in the range of 750-900 m²/m².

This specification also describes an immersed membrane module having a permeate port on the top of a header. A connection between the module and a permeate collection tube may be made with a vertical movement, i.e. a movement perpendicular to the length of the header. A piston seal may be used between the permeate port of the header and the permeate collection tube. The permeate collection tube may be a horizontal structural part of a frame that holds the module, for example a peripheral horizontal element of the frame. A cradle may be used to lift the module relative to the permeate collection tube.

### BRIEF DESCRIPTION OF THE FIGURES

FIG. 1 is an isometric drawing of a prior art immersed membrane cassette.

FIG. 2 is an end view of the prior art cassette of FIG. 1.

FIG. 3 is an isometric drawing of the frame of a new immersed membrane cassette.

FIG. 4 is an end view of the new cassette.

FIG. 5 shows a cross section of the end of a module installed in the new cassette but not sealed.

FIG. 6 shows a cross section of the end of a module installed and sealed to the new cassette.

FIG. 7 is an isometric view of part of the module to frame connection.

FIG. 8 is a cross section of FIG. 7.

FIG. 9 is a wider angle isometric view of two modules attached to the frame.

### DETAILED DESCRIPTION

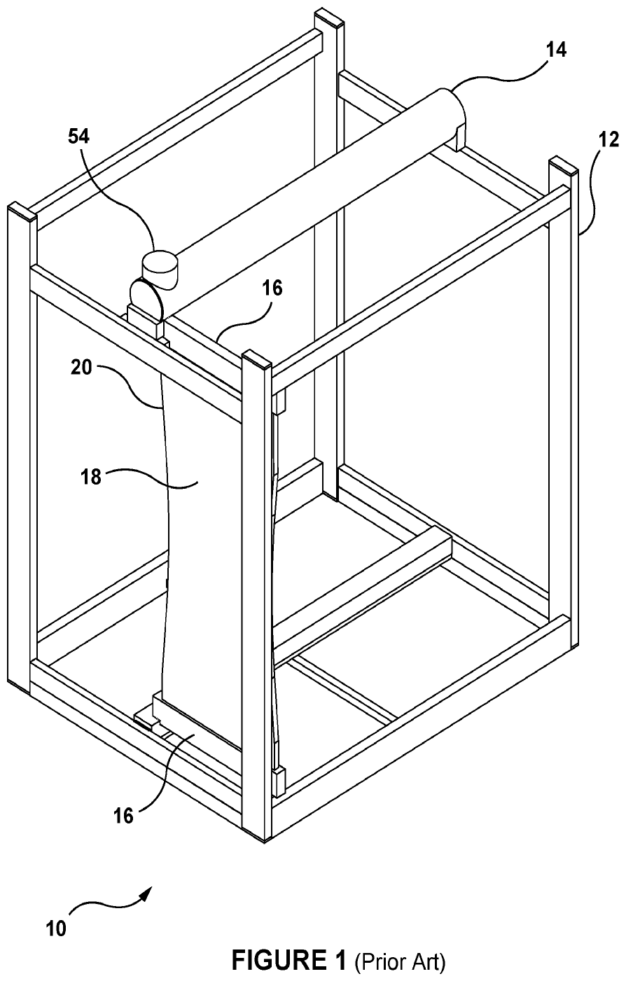

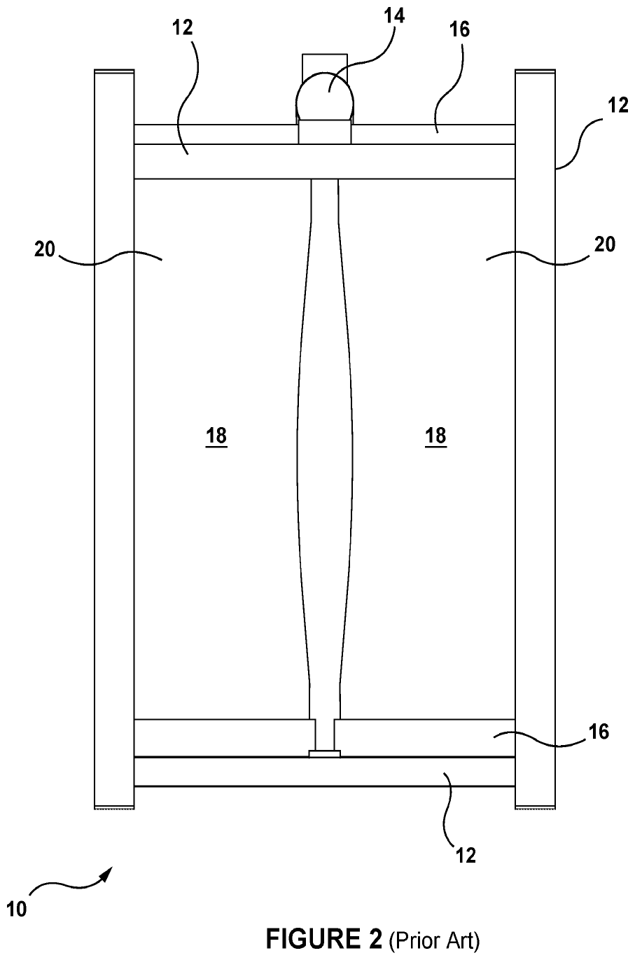

The ZeeWeed™ series of immersed membrane cassettes sold by Suez are commonly used in membrane bioreactors (MBRs) to treat wastewater using an activated sludge method. The current version in this series is the ZW500D model, shown in FIGS. 1 and 2. In this model, a cassette 10 has a steel frame 12 that supports a permeate collector pipe 14 and a plurality of modules 20. In FIG. 1, only one module 20 is shown to simplify the figure, but a cassette 10 may have 48 or 52 modules 20 when used to filter mixed liquor or 64 or 68 modules 20 when used to filter drinking water or for tertiary filtration. Each module 20 has upper and lower headers 16 and a plurality of hollow fiber membranes 18. In FIG. 1, the membranes 18 are shown as one unit to simplify the figure, but the module 20 actually has many individual hollow fiber membranes 18 extending between the headers 16. The membranes 18 are potted in resin in the headers 16. A permeate channel within the upper header 16 connects the lumens of the membranes 18 to a permeate port at the end of the header 16. A module 20 is installed by moving the module 20 horizontally (i.e. in a direction parallel with the length of the headers 16) into the side of the frame 12. As the module 20 reaches the center of the frame 12, the permeate port at the end of the header 16 slides horizontally into a fitting on the permeate collector pipe 14. As shown in FIG. 2, one module 20 is inserted into each side of the frame 12. A pair of modules 20 are placed back-to-back in the frame 12 but are spaced apart in the center of the cassette 10 by the permeate collector pipe 14.

Referring back to FIGS. 1, 24 to 34 modules 20 are placed side-by-side along each side of the cassette 10. Each module 20 is spaced apart from the next module 20 along the length of the cassette 10 by a gap, or opening. The gaps allow water to flow vertically between the modules 20. The gaps are sized to prevent the build up of solids and trash materials in the gaps. Conventional wastewater treatment plants typically employ coarse screening (with 6 mm openings or larger). Some trash materials that pass through the openings of the screen, for example hair or textile fabrics, are larger than the openings of the screen in one dimension and can combine with other trash fibers in the membrane tank to form larger ropes or balls. The gaps are typically 26 mm wide (measured as the clear spacing between proximal edges of the headers 16 of adjacent modules 20) in existing commercial cassettes 10 used to treat wastewater. The gaps may be smaller, for example 5 mm, when the cassette 10 is used to filter drinking water or for tertiary filtration.

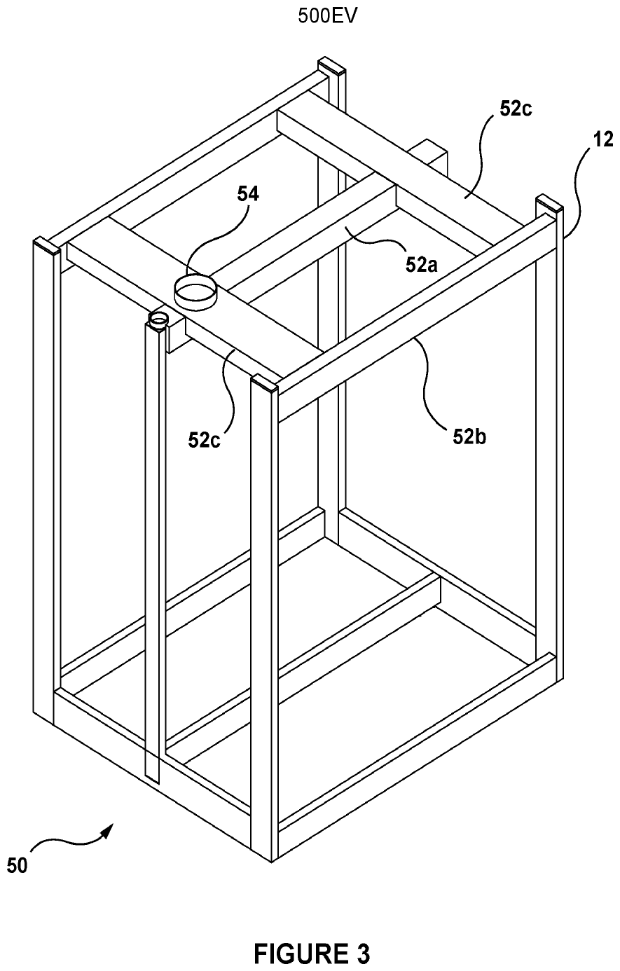

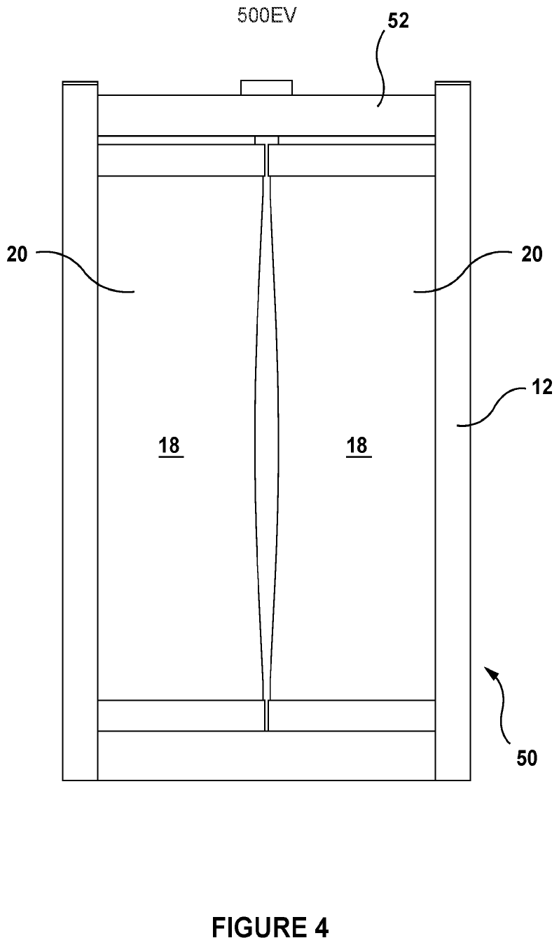

FIGS. 3 and 4 show a new cassette 50. The new cassette 50 has a higher tank intensity than the cassette 10 of FIGS. 1 and 2. Tank intensity (alternatively called footprint intensity) is expressed as the area of membrane surface area per unit area of tank footprint occupied by a single cassette 10, 50. In some applications multiple cassettes 10, 50 may be stacked vertically on top of each other but the tank intensity is still calculated on the basis of one cassette 10, 50. Since permeate (filtered water) production is proportional to (or at least related to) membrane surface area, a cassette with increased tank intensity can filter more water in a tank of a given plan view area. As a result of a number of changes, to be discussed further below, the new cassette 50 can have a tank intensity of over 650 m²/m², for example in the range of 650-900 m²/m² or 750-900 m²/m², when used to treat wastewater, for example by filtering mixed liquor. The new cassette 50 can have a tank intensity of over 900 m²/m², for example in the range of 900-1200 m²/m² when used to filter drinking water or for tertiary filtration. In comparison, the cassette 10 of FIG. 1 has a tank intensity of about 440-560 m²/m² when used for treating wastewater and about 630-750 m²/m² when used for filtering drinking water. Maximizing the membrane tank intensity results in a higher volume of water treated per unit area of tank footprint. For wastewater plant operators, this reduces the land area requirement and reduces the cost of construction for the wastewater treatment infrastructure. The new cassette 50 also has a higher packing density (surface area of membranes per unit volume of cassette).

Referring to FIG. 4, the new cassette 50 has a frame 12 that holds two modules 20 back-to-back in the frame 12. Compared to FIG. 2, the horizontally engaging permeate connections at the permeate collector pipe 14 of cassette 10 have been removed and the back-to-back spacing between the modules 20 in FIG. 4 is thereby reduced. As described for the cassette 10, each half of the new cassette 50 also has a series of modules 20 (not shown in FIG. 3) placed side-by-side along each side of the frame 12. However, the gap between modules 20 placed side-by-side along each side of the cassette 50 is reduced, relative to the cassette 10 of FIG. 1, to 20 mm or less, or 15 mm or less, or 8 to 12 mm, for a cassette 10 used to treat wastewater, i.e. to filter mixed liquor. In a cassette 10 used to filter drinking water or for tertiary filtration, the gap between modules may be in the range of 4-8 mm. Optionally, the center-to-center spacing between membranes 18 (fiber pitch) is also reduced from 3 mm in a module 20 of the prior art cassette 10 to about 2.7 mm in the new cassette 50. Optionally, open spaces between bundles of membranes 18 in a module 20 and/or open spaces between the edge of the membranes 18 and the end of a module 20 may be reduced or eliminated.

The reduced gap between modules 20 increases tank intensity but would be expected to make the new cassette 50 more susceptible to trash fouling. However, combining the new cassette 50 with a primary clarifier and/or fine-screen allows reduces fouling by trash. Fine-screening in particular allows the new cassette 50 to operate despite the reduced module-to-module gap. A fine screening system may provide an average trash concentration in the MBR mixed liquor of <2 mg/L, wherein trash is measured as dried solids retained by a 1.0 mm or ASTM No. 18 sieve. In an example of a measurement method, a sample of a known volume of mixed liquor in the range of 60-200 L is poured through one or more sieves wherein the only or bottom and smallest sieve is a 1.0 mm or ASTM No. 18 sieve. Solids retained on the one or more sieves are rinsed with potable water, dried at 105° C. for 8 hours, and weighed. The mass of dried solids is divided by the initial sample volume to determine the trash concentration. Suitable fine screens to remove trash from influent to an MBR may have an opening size, measured as the maximum distance across the opening passing through the geometric center of the opening, in the range of 1-4.5 mm or 2-4.5 mm. The openings are preferably round, with a diameter in the range of 1-3 mm or 2-3 mm, or square, with a width of 1-3 mm or 2-3 mm, as opposed to wedge-wire style. The screen may be made, for example, of a perforated metal sheet or woven wires. The openings may deform in use. Internally fed rotating drum style screens are preferred because they are less susceptible to mechanical failures resulting in bypassing of the screen.

Referring to FIG. 3, the frame 12 of the new cassette 50 has one or more structural hollow tubing sections 52. The hollow tubing sections 52 operate as permeate collection pipes and also provide some of the supporting structure members of the frame 12. As discussed further below, the modules 20 have permeate ports on the top of their upper headers 16. A fluid pathway from the lumens of the membranes 18 to a permeate collection port 54 is completed by connecting a permeate port of a module 20 to a hollow tubing section 52. In the example described herein, the permeate ports of the modules 20 connect to a hollow tubing section 52b extending along the length of the outside edge of the new cassette 50. Permeate then flows through hollow tubing sections 52c and 52a to the permeate collection port 54. Referring to FIG. 4, the modules 20 can be placed closer back-to-back in the new cassette 50, or the length of the modules 20 can be increased, compared to the cassette 10 of FIG. 1.

Reducing the back-to-back spacing between modules 20 increases tank intensity. In addition, the modules 20 in the cassette 10 of FIG. 1 have permeate ports on the ends of the headers 16. The size of this port is limited by the size of the permeate channel within the header 16. If the number of membranes 18 in a module 20 is increased, a larger permeate port is also required. In the configuration of the cassette 10 of FIG. 1, a taller or wider header 16 is needed to increase the size of the permeate port. Both a taller header and a wider header will adversely affect the tank intensity of a cassette 10. The maximum height of a cassette 10 is typically limited, for example by tank depth, crane working room requirements, shipping container limits or other concerns, so a taller header 16 requires shorter membranes 18. Moving a permeate port to the top of the headers 16 in the new cassette 50 allows the size of the permeate port to be increased without increasing the height or width of the module 20 or the side-by-side gap between modules 20. By moving the permeate port to the top of the header 16, the size of the permeate port is less dependent on the cross-sectional area of the permeate channel within the header 16. The permeate port can be made larger to accommodate increased flow from a module 20 with more membranes 18 without affecting the tank intensity of the cassette 50. The connection between the permeate port on the header 16 and the hollow tubing section 52b, or optionally a separate permeate collection pipe, is made by moving the module 20 vertically, perpendicular to the direction that the module 20 is installed in the frame 12 and/or perpendicular to the length of the header 16.

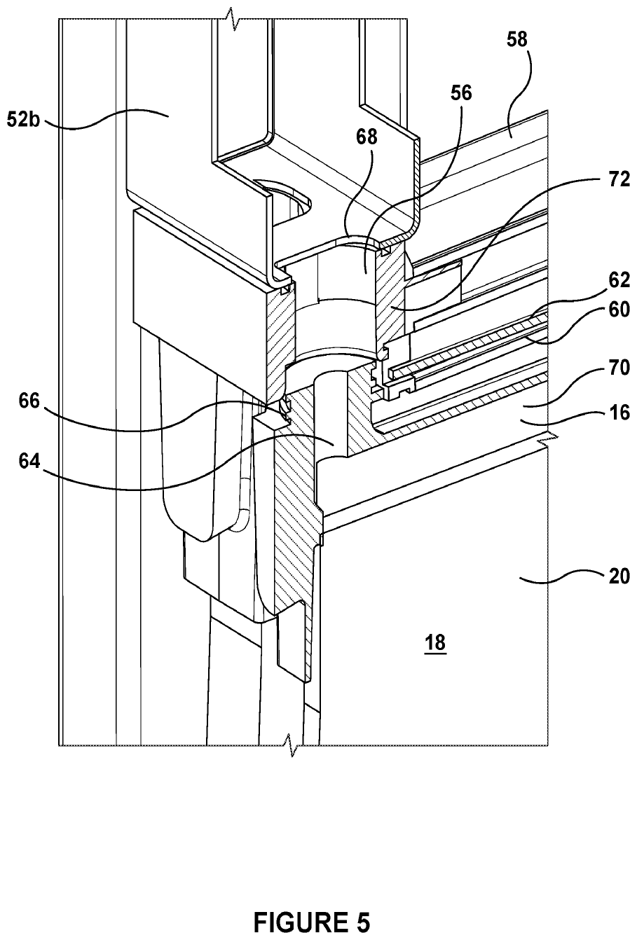

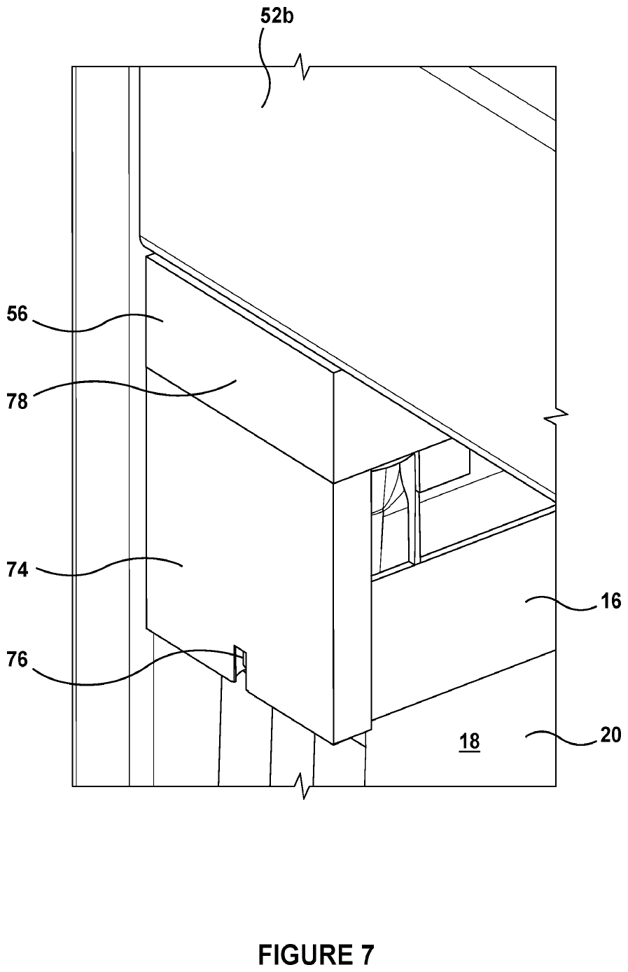

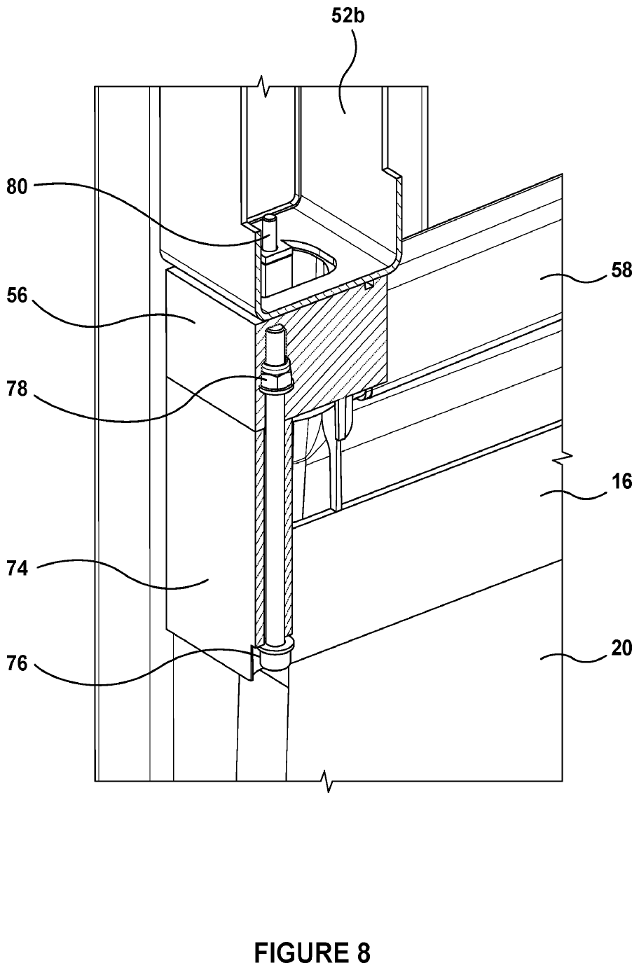

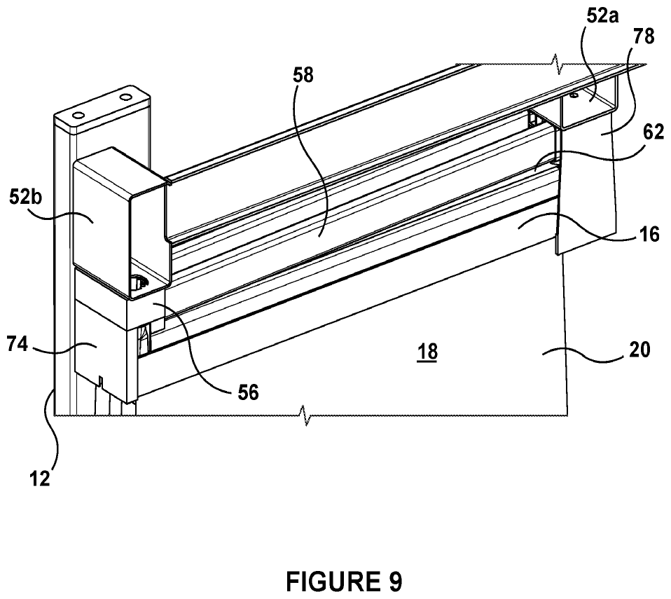

Referring to FIGS. 5 to 9, the hollow tubing section 52b is a hollow square section (HSS) steel tube. The hollow tubing section 52b has a series of openings 68 on the lower face of the square section. The opening 68 has an adapter 56 bolted over it. Bolts 80 used to attached the adapter 56 to the hollow tubing section 52b may be within the permeate flow channel. The adapter 56 holds one end of a rail 58. The other end of the rail 58 is supported by a bracket 78 connected to hollow tubing section 52a. The rail has a horizontal slot 60. The header 16 has a horizontally extending T-shaped flange 62 that slides in the slot 60. The flange 62 and slot 60 support the weight of the module 20 while the module 20 is slid into the frame 12. However, the slot 60 is deeper than the wings of the flange 62. This allows for a range of vertical movement of the module 20 up and down relative to the rail 58. In the example shown, there is a rail 58 for each module 20. Each set of an adapter 56 and a bracket 78 holds two rails 58, and thereby supports two modules 20

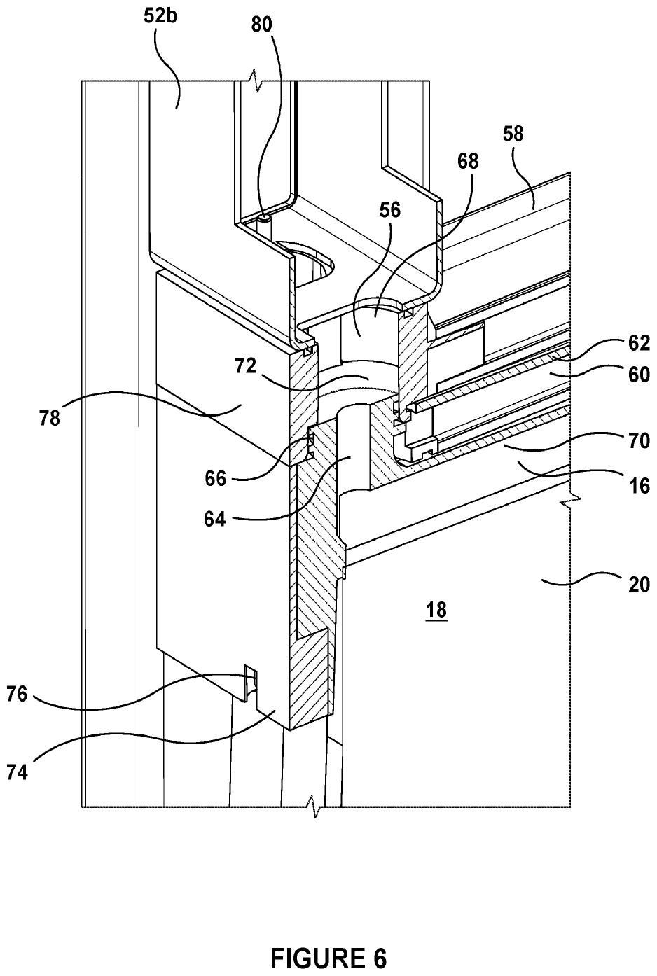

The header 16 has a permeate port 64 that extends upwards from the top of the header 16. The permeate port 64 is in fluid communication with a permeate channel 70 inside the header 16. The permeate channel 70 is in fluid communication with lumens of the membranes 18. The permeate port 64 has one or more peripheral grooves 66. Although not shown in FIGS. 5 and 6, the peripheral grooves 66 are fitted with a sealing material, for example an O-ring.

The permeate port 64 fits into a corresponding receiving port 72 of the adapter 56. After the module 20 is slid into place, a cradle 74 is placed over the end of the header 16. Optionally, a cradle 74 can be fit to the end of one or more headers 16, for example two headers 16 in the example shown. A bolt 76 extends from the cradle 74 to a nut 78 in the adapter 56. Tightening the bolt 76 lifts the module 20. This raises the permeate port 64 into the receiving port 72, whereby the sealing material creates a seal between the header 16 and the hollow tubing section 52b.

Optionally, the end of the header 16 may be designed to include the functions of the cradle 74 and a separate cradle 74 may be omitted. However, a separate cradle 74 usefully distributes a point load from the bolt 76 over a larger area of the header 16. The cradle 74 also protects the ends of the headers 16. The cradle 74 thereby assumes risks of breakage or damage. However, the cradle 74 is a relatively small and inexpensive part that is accessible from the outside of the new cassette 50 and can be easily replaced. Further, a crack in the cradle 74 does not create a leak in the permeate flow path.

Optionally, contact between the cradle 74 and the adapter 56 and/or between the flange 62 and the top of the slot 60 acts as a “stopper” to prevent excess upward movement of the header 16 without applying a force against the permeate port 64. The stopper also allows tension to build in the bolt 76, which can bind the threads of the bolt 76 in a nut 78 on the adapter 56 and/or activate a lock washer to inhibit loosening of the bolt 76 in use.

To remove a module 20, the bolt 76 is loosened. The module 20 is then pulled downwards to remove the permeate port 64 from the adapter 56. Optionally, the module 20 can be moved from side to side to help break the seal.

The seal as discussed above may be called a piston seal since it involves sliding one part, the “piston” into another part, the “bore”. In the example described herein, the piston is part of the header 16 and the bore is part of the adapter 56 connected to the permeate collection pipe 52b. Optionally, the piston may be part of the adapter 56 connected to the permeate collection pipe 52b and the bore may be connected to the header 16.

Optionally, other types of seal might be used. However, the inventors experimented with a face seal and found that the flexing of parts under load and fabrication tolerances made the seal unreliable. By moving to a piston seal several benefits could be observed. The piston seal is tolerant of typical fabrication tolerances for molded plastic parts. The piston seal can maintain a seal even when components flex or otherwise move when loaded. The piston seal, optionally coupled with a stopper, positively locates the module header relative to the frame. The cradle 74 lifts the module into place and securely fixates the module into the cassette frame 12. From a serviceability perspective, there is an advantage in having all the permeate seals on the outside of the cassette 50 where they are accessible.

The parts work together to create a robust fixation and sealing method while at the same time allowing for a larger permeate port 64. The size of the permeate port 64 is increased without affecting the module 20 width or height or the module to module gap. In this example, the larger permeate port 64 accommodates a module 20 with more membrane surface area. However, the use of a permeate port 64 on the top of a header 16 and piston seal may be adapted to other cassette designs. A larger permeate port can reduce pressure loss to product (permeate) flow and thereby provide larger transmembrane pressure (TMP) and/or reduced operational cost.

1. An immersed membrane cassette comprising,
a frame; and,
a plurality of modules, each module having a plurality of hollow fiber membranes extending vertically when in use and mounted between an upper header and a lower header, wherein the plurality of modules are selectively mounted on the frame,
wherein the immersed membrane cassette has one or more of: a gap between modules of 20 mm or less or 15 mm or less; structural hollow tubing in at least a parts of the frame configured to provide a permeate collection pipe; and, permeate ports in the tops of the upper headers selectively connected to the permeate collection pipe through a vertical motion.

2. The cassette of claim 1 having a tank intensity over 650 m2/m2, for example in the range of 750-900 m2/m2, for use in treating wastewater or over 900 m2/m2 for use in filtering drinking water or tertiary filtration.

3. The cassette of claim 1 wherein the gap between modules is 15 mm or less, for example in the range of 8 to 15 mm or 8 to 12 mm, for use in treating wastewater, or 4-8 mm for use in filtering drinking water or tertiary filtration.

4. The cassette of claim 1 in combination with an upstream clarifier or fine screen.

5. The cassette of claim 1 in combination with a screen having openings with a maximum dimension measured through the geometric center in the range of 1-4.5 mm.

6. The cassette of claim 5 wherein the screen is part of an internally fed rotating drum screen.

7. An activated sludge wastewater treatment process comprising the steps of,
filtering mixed liquor through an immersed membrane cassette, wherein the immersed membrane cassette comprises a frame and a plurality of modules, each module having a plurality of hollow fiber membranes extending vertically when in use and mounted between an upper header and a lower header, wherein the plurality of modules are selectively mounted on the frame, wherein the cassette has a tank intensity of at least 650 m2/m2; and,
screening influent wastewater, recirculating activated sludge and/or or mixed liquor to provide an average trash level in the mixed liquor around the cassette of <2 mg/L.

8. The process of claim 7 wherein the step of screening is performed with a screen having openings with a maximum dimension measured through the geometric center in the range of 1-4.5 mm.

9. The process of claim 7 wherein the cassette has a tank intensity in the range of 750-900 m2/m2.

10. The process of claim 7 wherein the cassette has a gap between modules of 20 mm or less, or 15 mm or less, or in the range of 8-12 mm.

11. An immersed membrane cassette comprising,
a frame;
a plurality of modules, each module having a plurality of hollow fiber membranes extending vertically when in use from an upper header, wherein the plurality of modules are selectively mounted on the frame; and,
permeate ports in the tops of the upper headers.

12. The cassette of claim 11 wherein the permeate ports are selectively connected to a permeate collection pipe through a vertical motion.

13. The cassette of claim 11 wherein the permeate collection pipe is a structural hollow section of the frame.

14. The cassette of claim 11 comprising rails mounted to the frame for sliding the modules into the frame.

15. The cassette of claim 11 comprising a cradle adapted to lift an end of a module relative to the frame.

16. The cassette of claim 11 comprising a piston seal between the upper headers and the permeate collection pipe.

17. The cassette of claim 11 wherein the permeate collection pipe is a horizontal structural member on a peripheral edge of the frame.
